(19) United States
(12) Patent Application Publication
(10) Pub. No.: US 2015/0167848 A1
(43) Pub. Date: Jun. 18, 2015

(54) WHEEL VALVE

(71) Applicant: SHINSEUNG PRECISION INDUSTRY LTD., Changwon-si Gyeongsangnam-do (KR)

(72) Inventor: Keun Jin Jang, Seoul (KR)

(73) Assignee: SHINSEUNG PRECISION INDUSTRY LTD., Changwon-si Gyeongsangnam-do (KR)

(21) Appl. No.: 14/361,244

(22) PCT Filed: Jun. 26, 2013
(86) PCT No.: PCT/KR2013/005650

§ 371 Date: May 28, 2014

(30) Foreign Application Priority Data
May 21, 2013 (KR) 10-2013-0056814

(51) Int. Cl. F16K 1/16; F16K 27/02; F16K 1/46

(52) U.S. Cl. CPC F16K 1/16; F16K 1/46; F16K 27/0272; F16K 27/0227

(57) ABSTRACT

Disclosed is a wheel valve for use in a central tire inflation system. The wheel valve contains therein a rotary poppet which contacts a casing member at three points, thereby providing a simple structure. The wheel valve does not employ a diaphragm valve, ensuring a reliable operation without operational error due to introduction of foreign matter.

### CROSS-REFERENCE TO RELATED APPLICATIONS

This application is a national phase of International Application No. PCT/KR2013/005650, filed Jun. 26, 2013, which claims the benefit of Korean Application No. 10-2013-0056814, filed May 21, 2013, in the Korean Intellectual Property Office. All disclosures of the document(s) named above are incorporated herein by reference.

### BACKGROUND OF THE INVENTION

1. Field of the Invention

The present invention relates, in general, to a wheel valve and, more particularly, to a wheel valve which is used in a central tire inflation system so as to inflate or deflate each tire of a vehicle.

2. Description of the Related Art

Generally, a central tire inflation system (referred hereinafter to as a ‘CTIS’) is a system to provide remote control over the air pressure in tires of a vehicle while stopped and/or driven typically using a vehicle-mounted pressure source (e.g. an air brake compressor or a storage tank in a vehicle). Thus, the CTIS allows a driver to manually and/or automatically control the air pressure of one or more tires of a vehicle (typically a truck) that is stopped or being traveled in, using an air supply system in the vehicle.

A wheel valve is generally located at a rim or a hub of a wheel so as to selectively inflate or deflate a tire fitted around the rim of the wheel. That is, air flows in and out of the tire through the wheel valve, thereby increasing or decreasing the air pressure of the tire, which varies the riding quality and operation performance of a vehicle as well as the operation performance of a tire.

FIG. 1 is a constructional view of a CTIS using an air tank mounted under a vehicle body. The CTIS is configured such that compressed air compressed by an air compressor 110 is stored in an air tank 150, and the compressed air is distributed via a manifold 140 and supplied to each tire 200 through the wheel valve 100 under automatic or manual control of a controller 120 in response to a speed detected by a speed sensor.

Such a wheel valve has a variety of conventional structures of which a representative example is shown in FIG. 1. Most of the conventional wheel valves use a diaphragm valve which, however, has problems in that an internal structure thereof is complex, the diaphragm valve is formed from a rubber material so that the diaphragm valve is likely to be torn and thus broken down, and so on.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) U.S. Pat. No. 5,540,268 (published on Jul. 30, 1996)

### SUMMARY OF THE INVENTION

Accordingly, the present invention has been made keeping in mind the above problems occurring in the related art, and the present invention is intended to propose a wheel valve which has a simple structure and thus is easy to manufacture, and is able to operate normally even when foreign materials are introduced internally.

In order to achieve the above object, according to one aspect of the present invention, there is provided a wheel valve including a rotary poppet and a casing member accommodating the rotary poppet, wherein the rotary poppet includes a poppet body which has upper and lower surfaces, from which first and second shaft parts respectively protrude oppositely, and a lateral surface, wherein the lateral surface of the poppet body includes a first lateral side located along a vertical central phantom line of the first shaft part, and second and fourth lateral sides located either along a horizontal central phantom line of the first shaft part perpendicular to the vertical central line, or opposite the first lateral side with reference to the horizontal central line, horizontally symmetrically with the vertical central line, wherein the casing member is provided with an inlet port and an outlet port, which are located opposite, and an internal accommodating space for the rotary poppet, which are arranged to form a passage through which air flows successively via the inlet port, the accommodating space, and the outlet port, wherein a side wall of the accommodating space in the casing member has a planar shape that comes into contact with the rotary poppet only at the first, second, and fourth lateral sides. In another aspect, the present invention provides a wheel valve including a casing member which has an inlet port connected with a tire nozzle, an outlet port connected with an air compressor, and a passage connected between the inlet port and the outlet port and through which air flows, and a rotary poppet pivotably mounted in the passage, wherein the rotary poppet has a planar shape that comes into contact at three points with an inner wall of the passage.

According to the present invention, the wheel valve has a simple structure in which a rotary poppet is provided in a casing member, and is easy to manufacture, thereby saving on manufacturing cost. Further, the wheel valve is implemented without using a diaphragm valve, which is likely to be frequently broken due to introduction of foreign matter, thereby improving reliability of the product.

Additional aspects and/or advantages of the invention will be set forth in part in the description which follows and, in part, will be obvious from the description, or may be learned by practice of the invention.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a constructional view of a central tire inflation system (CTIS) using an air tank mounted under a vehicle body;

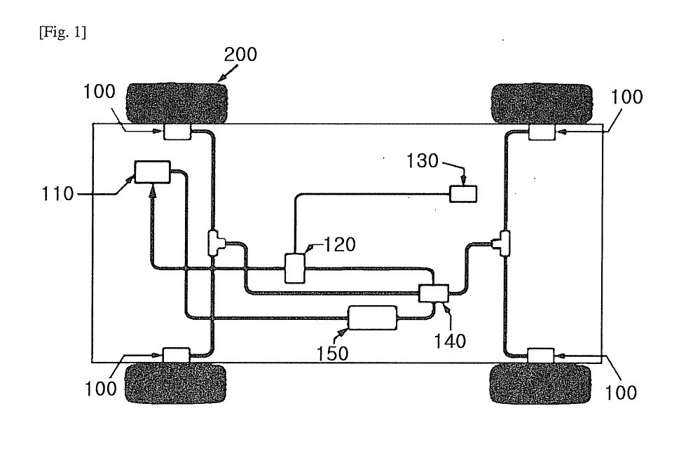

FIGS. 2A to 2C are views showing an exemplary embodiment of a wheel valve for use in the CTIS, wherein the wheel valve is shown in a plan view, a front view, and a vertical sectional view, respectively;

FIGS. 3A and 3B are perspective views of the wheel valve shown, in two versions, one having a rotary poppet and the other omitting the rotary poppet;

FIGS. 4A to 4D are views of the rotary poppet to be inserted into the wheel valve;

FIGS. 5A and 5B are views showing a casing member in which a passage is formed and the rotary poppet is mounted in the passage;

FIGS. 6A to 6C are sectional views showing the operation of the wheel valve; and

FIG. 7 is a graph showing the air pressure of a tire that decreases over the time by means of the wheel valve.

### DETAILED DESCRIPTION OF THE EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

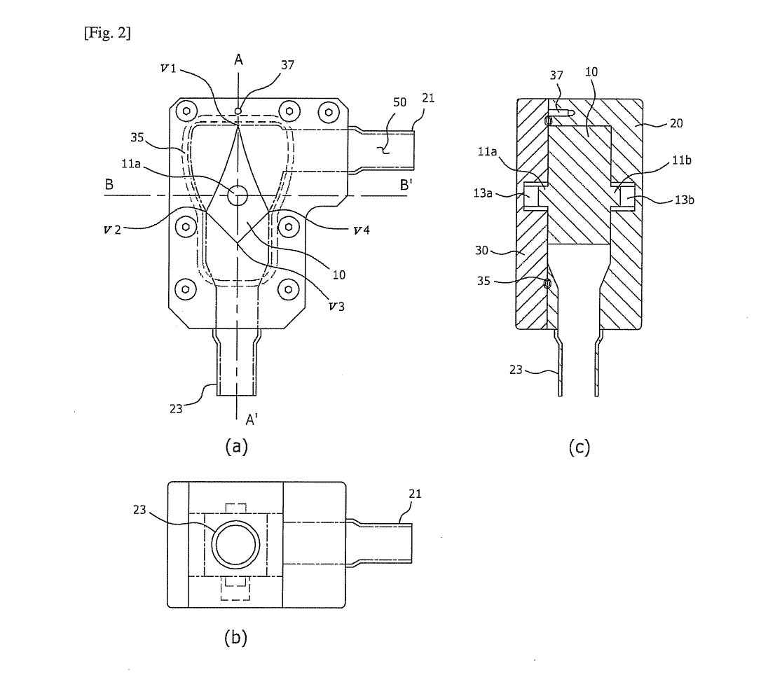

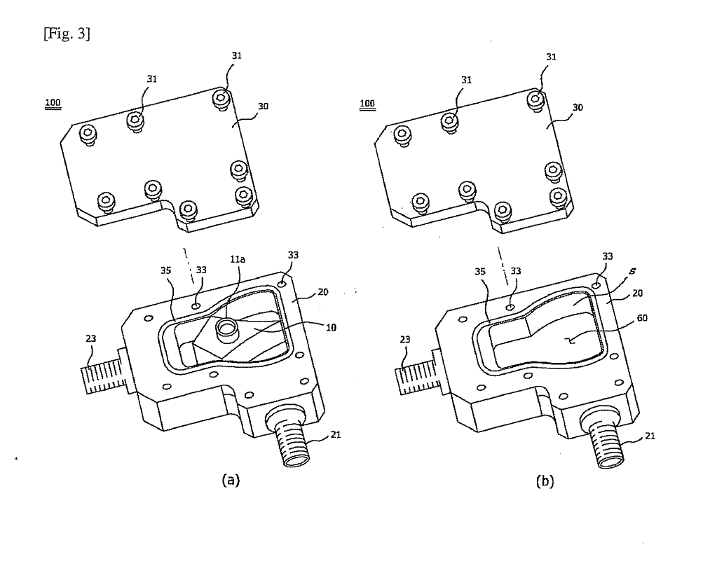

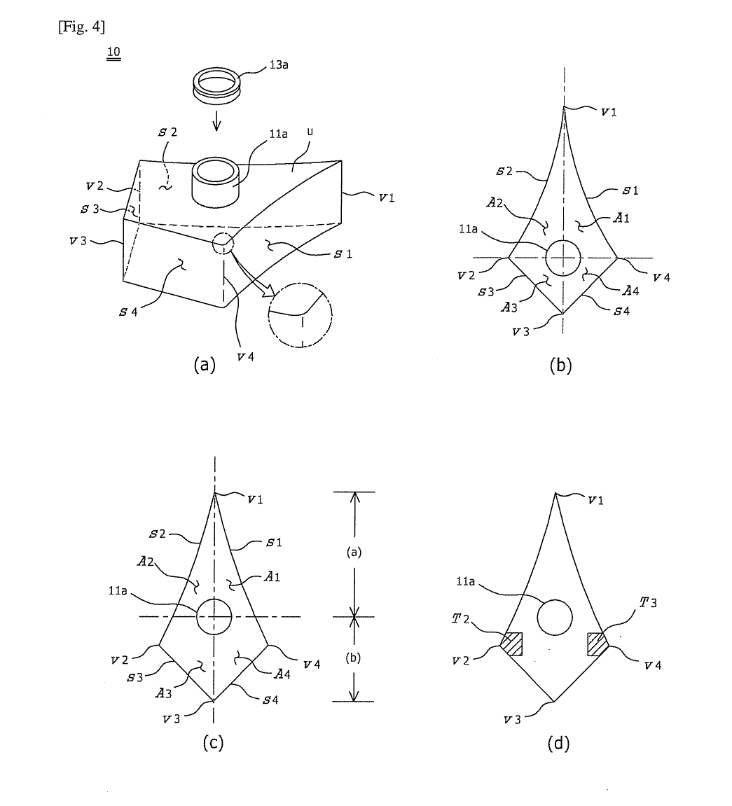

FIG. 2A is a partially-penetrated plan view of a wheel valve according to an embodiment of the present invention. FIG. 2B is a front view of FIG. 2A, and FIG. 2C is a cross-sectional view taken along line A-A′ in FIG. 2A. FIG. 3A is an exploded perspective view of the wheel valve, and FIG. 3B is an exploded perspective view of the wheel valve from which a rotary poppet is omitted. FIGS. 4A to 4D are views of the rotary poppet to be inserted into the wheel valve. The structure of the wheel valve will be described with reference to FIGS. 2A to 2C and FIGS. 4A to 4D.

The wheel valve includes a rotary poppet 10 and a casing member 20 and 30 which has an accommodation space 60 in which the rotary poppet is accommodated.

The rotary poppet 10 includes a poppet body which has an upper surface u, a lower surface, and lateral surfaces s1, s2, s3, and s4, wherein first and second shaft parts 11a and 11b which oppositely protrude from the upper and lower surfaces, respectively. The poppet body and the shaft parts are integrally formed with the same material using a grinding or die casting method. The upper and lower surfaces have a rectangular planar shape like a kite, and, as shown in FIGS. 4A and 4B, have first to fourth lateral sides v1, v2, v3, and v4, which are defined by an intersection between s1 and s2; s2 and s3; s3 and s4; and s4 and s1, respectively. Here, the term ‘lateral side’ used herein means a lateral side that is defined by intersection between adjoining lateral surfaces. That is, as shown in FIG. 4A, the first lateral side v1 is defined as the line where the first and second lateral surfaces s1 and s2 intersect; the second lateral side v2 is defined as the line where the second and third lateral surfaces s2 and s3 intersect; the third lateral side v3 is defined as the line where the third and fourth lateral surfaces s3 and s4 intersect; and the fourth lateral side v4 is defined as the line where the fourth and first lateral surfaces s4 and s1 intersect. Further, as shown in the figures, the first and second lateral surfaces s1 and s2 are provided in a shape not linear, but curved towards the shaft part when the poppet body is seen in a plan view. The curved shape enables the air flow being applied to the rotary poppet 10 to be more smoothly applied to the first and second lateral surfaces s1 and s2. Accordingly, it should be understood that strictly speaking, the above expression of the upper and lower surfaces of the rotary poppet 10 having the rectangular planar shape like a kite means the planar shape of the upper and lower surfaces is a kite-like rectangular shape of which some of lateral surfaces may be curved towards the shaft part when the rotary poppet is seen in a plan view. However, a profile of the rotary poppet may also have a flat planar shape, so it should be construed that the expression ‘kite-like shape’, ‘kite-like rectangular shape’, or the like, which is described in the following description and claims, means the shape of which some of lateral surfaces have a flat or curved planar rectangular shape.

As shown in FIGS. 2A to 2C and FIGS. 4A to 4D, the first and second shaft parts 11a and 11b are fitted into recesses of upper and lower parts 30 and 20, respectively, of the casing member, with shaft seals 13a and 13b fitted around the first and second shaft parts, respectively. The shaft seals 13a and 13b are formed of ethylene propylene diene M-class (EPDM) rubber.

As shown in FIGS. 2A to 2C and FIGS. 4A to 4D, the first and third lateral sides v1 and v3 are located opposite with reference to a vertical central phantom line (line A-A′ in FIG. 2A) passing through the center of the shaft part 11a or 11b, and the second and fourth lateral sides v2 and v4 are located either along a horizontal central phantom line (line B-B′ in FIG. 2A) passing through the shaft part 11a or 11b (see FIG. 4B), or opposite the first lateral side v1 with reference to the horizontal central line (see FIG. 4C), horizontally symmetrically with reference to the vertical central line.

It is preferred that the rotary poppet 10 shown in FIG. 4B be formed in such a way that two-part volumes A3 and A4 of a lower section relative to the horizontal central line of the first shaft part 11a are the same as volumes A1 and A2 of an upper section relative to the horizontal central line. This is because the first shaft part 11a is designed to serve as the center of weight in order to maintain stable operation of the rotary poppet as will be described later. Thus, in order to match with opposite-side volumes, the first and second lateral surfaces s1 and s2 should be designed to be considerably curved inwards to reduce the upper-side volumes A1 and A2. However, in order to prevent the first and second lateral surfaces s1 and s2 from being excessively curved inwards, as shown in FIG. 4C, the position of the first shaft part 11a, which serves as the center of weight, is moved vertically upwards so that the second and fourth lateral sides v2 and v4 are opposite the first lateral side v1 with reference to the moved-up horizontal central line of the first shaft part 11a. That is, the configuration of FIG. 4C is designed such that the volumes A1 and A2 above the horizontal central line are the same as the volumes A3 and A4 below the horizontal central line.

Further, as shown in an enlarged scale with a circle in FIG. 4A, the first, second, and fourth lateral sides v1, v2, and v4 are formed to be round in order to improve smooth and sealable engagement with side walls S of the casing member. As shown in FIG. 4C, it can be seen that a first distance (a) from the shaft part to the first lateral side v1 be longer than a second distance (b) from the shaft part to the third lateral side v3. The rotary poppet 10 is formed of brass. Further, as shown in FIG. 4D, it is also possible to form the rotary poppet 10 such that the rotary poppet is made of brass and the second and fourth lateral sides v2 and v4 are chamfered to form chamfered recesses T2 and T3, which are then filled with Teflon coating.

The casing member comprises a lower body (or a lower part) 20 and an upper cover (or an upper part) 30. The lower body 20 is provided with an inlet port 21 and an outlet port 23, which are located opposite, and an internal accommodating space 60, which are all connected in communication with each other so as to form a passage 50 through which air flows. Compressed air stored in the air compressor or the air tank is supplied into the accommodating space through the inlet port 21, and is discharged from the accommodating space to a nozzle of a tire through the outlet port 23. The surface of the casing member to define the accommodating space 60 will be referred to as an ‘inner surface’, and a portion of the surface to face the lateral surfaces of the rotary poppet 10 will be referred to as a ‘side wall (S)’. An O-ring 35 is mounted on the upper surface of the lower body 20 around a circumference of an opening of the accommodating space 60, and a plurality of screw holes 33 are formed on the upper surface of the lower body around the O-ring 35. The upper cover 30 is provided with a plurality of through-holes which correspond to the screw-holes 33 on the upper surface of the lower body 20, so that the upper cover and the lower body are coupled by screws 31 into the screw holes 33 through the through-holes. In addition, the upper cover 30 and the lower body 20 are coupled together in a precisely aligned manner by means of a guide pin-hole engagement 37. The lower body 20 and the upper cover 30 may be formed of aluminum, and may be Teflon-coated at least on the surface where the lower body and the upper cover come into contact with the rotary poppet 10.

As shown in FIG. 2C, the rotary poppet 10 is hermetically sealed with the casing member such that the upper and lower surfaces thereof are brought into close contact with the lower body 20 and the upper cover 30. To this end, the inner surfaces of the lower body 20 and the upper cover 30 to be coupled to define the passage and the accommodating space 60 may also be Teflon-coated. Thus, the surfaces of the rotary poppet 10 and of the lower body 20 and the upper cover 30 contacting the surface of the poppet may be all coated with Teflon, thereby improving sealability between the rotary poppet 10 and the casing member and reducing friction coefficient therebetween.

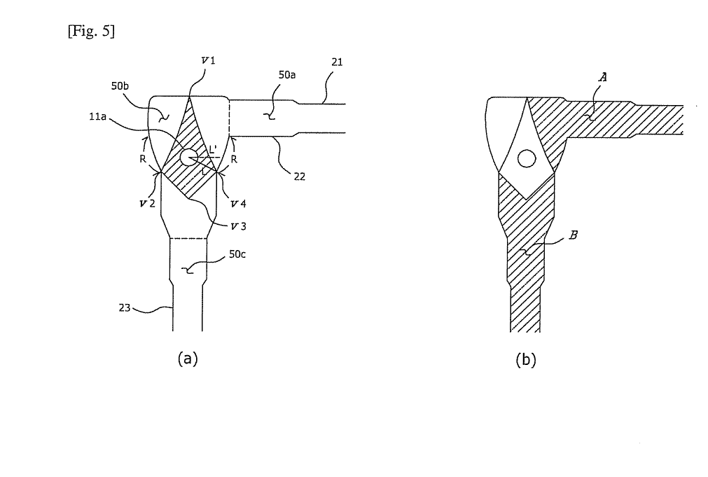

FIGS. 5A and 5B are views showing the casing member in which the passage is formed and the rotary poppet is mounted in the passage. Here, the figures only illustrate the passage 22 in the casing member, wherein, for easy description, the passage 22 is illustrated to comprise an inlet section 50a, a poppet section 50b, and an outlet section 50c. The rotary poppet has two statuses: a stable status in which there is no air flow in the passage, and an unstable status in which there is air flow in the passage. FIGS. 5A and 5B show the rotary poppet in the stable status in which the rotary poppet 10 is in contact with the surface of the passage in the casing member only at the first, second, and fourth lateral sides v1, v2, and v4. Thus, in the stable status, the rotary poppet 10 and the surface of the passage in the casing member should be brought into hermetic, close contact with each other, and the contact portions may be Teflon-coated to facilitate separation therebetween when air flow occurs in the passage.

Further, the rotary poppet 10 may be designed to convert to an unstable status with a clockwise or counterclockwise swivel action about an axis of the shaft part 11a within a predetermined swivel angle, allowing air-circulation through the poppet section when the air flow occurs in the passage. Further, in order to allow the rotary poppet 10 to smoothly swivel in opposite directions in the accommodating space, as shown in FIG. 5A, the accommodating space 60 should be designed such that a channel between opposite surfaces contacting the second and fourth lateral sides v2 and v4 is made narrower than the other part of the passage. Further, the poppet section of the passage should be designed in such a manner that, when the rotary poppet 10 swivels counterclockwise in the accommodating space, a section (R) of the inner surface of the accommodating space does not interfere with the swiveling action of the fourth lateral side v4, wherein the section (R) of the inner surface extends from a first point where the fourth lateral side v4 is in contact with the inner surface of the accommodating space when the rotary poppet 10 is in the stable status to a second point where the inner surface meets the inlet section 50a of the passage. To this end, the section (R) of the inner surface of the accommodating space is formed to have a radius of curvature such that a distance from the center of the shaft part 11a to the section (R) is larger than a radius of curvature (L) of the fourth lateral side v4 that is described when the fourth lateral side v4 swivels. In FIG. 5A, reference sign L′ denotes a phantom radius of curvature of the fourth lateral side v4 when the further lateral side swivels counterclockwise about the shaft part 11a, wherein L′ is the same length as L. The principle to design the section (R) of the inner surface should be identically applied to the design of an opposite section of the inner surface of the accommodating space that faces the second lateral side v2 when the rotary poppet swivels clockwise in the accommodating space.

Further, for stable operation, as shown in FIG. 5B, it is preferably designed such that the pressure applied to the first lateral surface s1 of the rotary poppet through the inlet section (denoted as ‘A’) of the passage be the same as combined pressure applied to the third and fourth lateral surfaces s3 and s4 of the rotary poppet through the outlet section (denoted as ‘B’) of the passage.

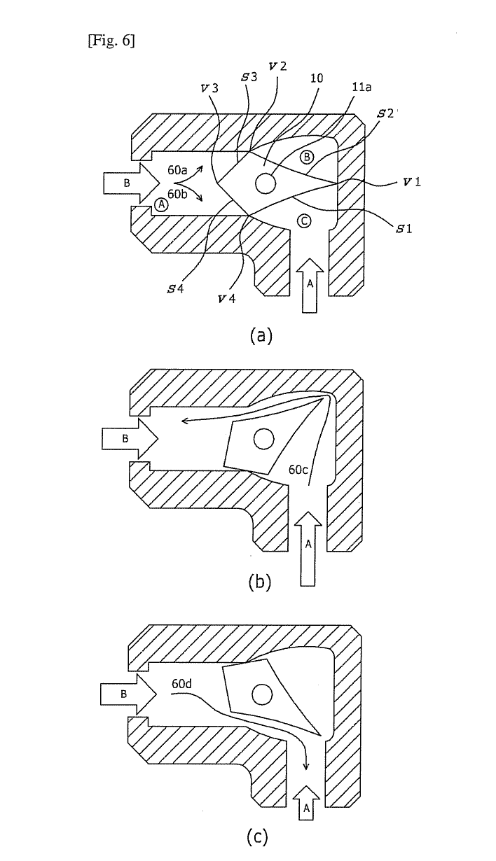

The operation of the wheel valve will now be described with reference to FIGS. 6A to 6C, wherein FIG. 6A shows the stable status of the rotary poppet in which air flow does not occur in the wheel valve, and FIGS. 6B and 6C shows the unstable status of the rotary poppet in which air flow occurs in the wheel valve. For convenience in explanation, the space defined by the inner surface of the accommodating space and the third and fourth lateral surfaces s3 and s4 of the poppet 10 is marked as \textcircled{A}; the space defined by the inner surface of the accommodating space and the second lateral surface s2 of the poppet 10 is marked as \textcircled{B}; and the space defined by the inner surface of the accommodating space and the first lateral surfaces s1 of the poppet 10 is marked as \textcircled{C}.

The stable status of FIG. 6A will now be described. In FIGS. 6A to 6C, the sectional area of the casing member is indicated by hatching, and empty space defined by the inner surface of the sectional area of the casing member indicates the passage. Arrow B illustrates the magnitude of the air pressure from a tire, and arrow A illustrates the magnitude of the air pressure applied from the air compressor or the air tank. The stable status shown in FIG. 6A is the status that is realized when the magnitude of the air pressure B from the tire exceeds the magnitude of the air pressure A applied from the air compressor or the air tank, thereby maintaining a current state without supplying or drawing the air pressure to or from the tire. When the magnitude of the air pressure B is higher than that of the air pressure A, the air pressure B to be applied to the tire is applied to the rotary poppet 10 such that two identically-divided parts of the air pressure are equally applied to the third and fourth lateral surfaces s3 and s4, respectively, thereby maintaining the state in which the rotary poppet 10 does not swivel about the shaft part 11a.

FIG. 6B shows the rotary poppet that has been converted to unstable status in the case where it is required to inject air pressure into a tire. When the wheel valve is applied, from the air tank, with air pressure A that is higher than air pressure B that is currently maintained in the tire, as shown in FIG. 6B, the first lateral surface s1 of the rotary poppet 10 is applied with the air pressure so that the rotary shaft swivels counterclockwise about the shaft part 11a, and then compressed air is injected into the tire through a space between the first lateral side v1 and the inner surface of the passage in the direction of arrow 60c. Then, when the air pressure B of the tire becomes equal to the air pressure A applied from the air tank, the rotary poppet is converted to the stable status of FIG. 6A.

In the stable status, mostly air pressures applied to the spaces \textcircled{A} and \textcircled{C} are substantially equally maintained. Thus, switching of the rotary poppet to the unstable status of FIG. 6B from the stable status of FIG. 6A can be theoretically accomplished only by applying a fraction of air pressure to the space \textcircled{C}. However, since the space \textcircled{B} also has a fraction of remaining air pressure, practically, the air pressure of 5 psi or more is to be applied for conversion of status, or otherwise the air pressure of approximately 100 psi is to be instantly applied for quick conversion of status.

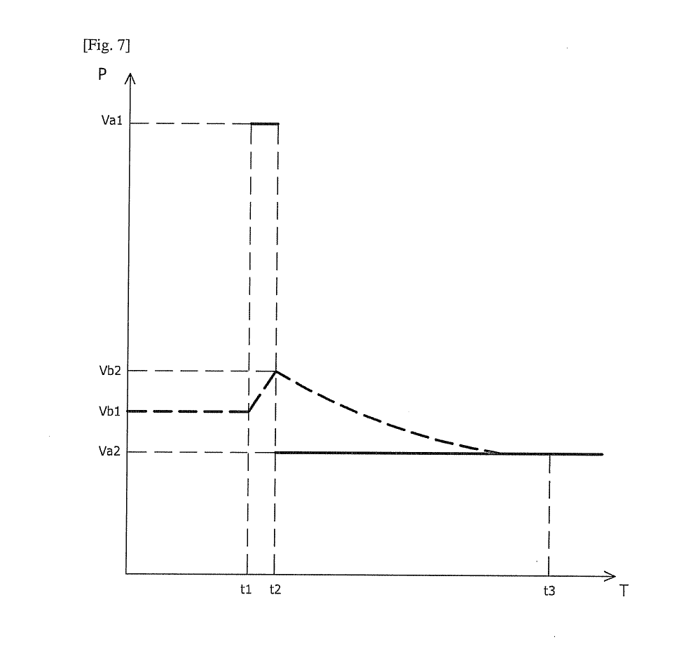

FIG. 6C shows the rotary poppet that is converted to unstable status when the air pressure of the tire is decreased. When it is required to decrease the air pressure B of the tire, the air pressure A should be lower than the air pressure B. However, as described with reference to FIG. 6A, the wheel valve maintains the stable status when the air pressure B is higher than the air pressure A. Thus, in order to lower the air pressure B of the tire using the present wheel valve, it is required to take additional measures. The measures will be described with reference to the graph of FIG. 7 that describes stages to decrease the air pressure of a tire using the present wheel valve. In FIG. 7, the vertical axis indicates air pressure, and the horizontal axis indicates time elapsed. It is shown that the air pressure of the tire is maintained at Vb1 in the period before t1. In order to decrease the air pressure of the tire to Va2, the air pressure of Va1 is instantly applied from an air tank in the period from t1 to t2. Thus, in that period from t1 to t2, the air pressure A that is higher than the air pressure B is instantly applied, so that the rotary poppet of the wheel valve is temporarily converted to the unstable status as shown in FIG. 6C. Then, when the air pressure of Va2 is applied from the air tank in the period after t2, the rotary poppet is converted from the status of FIG. 6B to the status of FIG. 6C, so that the rotary poppet maintains unstable status until t3 at which the air pressure of the tire is decreased, through air flow 60d, to the magnitude Va2 of the air pressure supplied from the air tank, and after t3, the rotary poppet swivels to the position of the stable status of FIG. 6A.

Although a preferred embodiment of the present invention has been described for illustrative purposes, those skilled in the art will appreciate that various modifications, additions and substitutions are possible, without departing from the scope and spirit of the invention as disclosed in the accompanying claims

1. A wheel valve comprising:
a rotary poppet and a casing member accommodating the rotary poppet,
wherein the rotary poppet includes a poppet body which has upper and lower surfaces, from which first and second shaft parts respectively. protrude oppositely, and a lateral surface,
wherein the lateral surface of the poppet body includes a first lateral side located along a vertical central phantom line of the first shaft part, and second and fourth lateral sides located either along a horizontal central phantom line of the first shaft part perpendicular to the vertical central line, or opposite the first lateral side with reference to the horizontal central line, horizontally symmetrically with the vertical central line,
wherein the casing member is provided with an inlet port and an outlet port, which are located opposite, and an internal accommodating space for the rotary poppet, which are arranged to form a passage through which air flows successively via the inlet port, the accommodating space, and the outlet port,
wherein a side wall of the accommodating space in the casing member has a planar shape that comes into contact with the rotary poppet only at the first, second, and fourth lateral sides.

2. The wheel valve as set forth in claim 1, wherein the lateral surface of the poppet body further includes a third lateral side located along the vertical central line of the first shaft part opposite the first lateral side with reference to the horizontal central line, so that the upper and lower surfaces of the rotary poppet have a kite-like shape.

3. The wheel valve as set forth in claim 2, wherein a portion of the lateral surface of the rotary poppet is curved towards the first shaft part.

4. The wheel valve as set forth in claim 1, wherein the inner wall of the accommodating space in the casing member is coated with Teflon.

5. The wheel valve as set forth in claim 4, wherein the casing member is formed of aluminum.

6. The wheel valve as set forth in claim 1, wherein the casing member has a lower body, in which the accommodating space, the inlet port, and the outlet port are integrally formed, and an upper cover covering an upper portion of the lower body.

7. The wheel valve as set forth in claim 6, wherein an O-ring is disposed between the upper cover and the lower body.

8. The wheel valve as set forth in claim 1, wherein the lateral surface of the poppet body is formed to be round at the first, second, and fourth lateral sides.

9. The wheel valve as set forth in claim 1, wherein a shaft seal is fitted around the shaft part of the rotary poppet.

10. A wheel valve comprising a rotary poppet and a casing member accommodating the rotary poppet,
wherein the rotary poppet comprises:
a poppet body which has upper, lower, and lateral surfaces,
first and second shaft parts respectively protrude oppositely from the upper and lower surfaces of the poppet body,
a first lateral side located along a vertical central phantom line of the first shaft part on the lateral surface of the poppet body, and
second and fourth lateral sides located either along a horizontal central phantom line of the first shaft part perpendicular to the vertical central line, or opposite the first lateral side with reference to the horizontal central line, horizontally symmetrically with the vertical central line,
wherein the casing member comprises:
an internal accommodating space for the rotary poppet,
an inlet port provided on a side,
an outlet port provided on the opposite side,
a passage formed in the casing member to let air flow successively via the inlet port, the accommodating space, and the outlet port, and
a recesses to which first and second shaft parts are inserted.

11. The wheel valve of claim 10, wherein a shaft seal is fitted around the shaft part of the rotary poppet.

12. The wheel valve of claim 11, wherein the shaft seal is formed of ethylene propylene diene M-class (EPDM) rubber.

13. The wheel valve as set forth in claim 2, wherein the inner wall of the accommodating space in the casing member is coated with Teflon.

14. The wheel valve as set forth in claim 2, wherein the casing member has a lower body, in which the accommodating space, the inlet port, and the outlet port are integrally formed, and an upper cover covering an upper portion of the lower body.

15. The wheel valve as set forth in claim 2, wherein the lateral surface of the poppet body is formed to be round at the first, second, and fourth lateral sides.

16. The wheel valve as set forth in claim 2, wherein a shaft seal is fitted around the shaft part of the rotary poppet.
